(19) United States
(12) Patent Application Publication
(10) Pub. No.: US 2016/0004549 A1
(43) Pub. Date: Jan. 7, 2016

(54) METHOD AND APPARATUS TO CONCEAL THE CONFIGURATION AND PROCESSING OF THE REPLICATION BY VIRTUAL STORAGE

(71) Applicant: HITACHI, LTD., Chiyoda-ku, Tokyo (JP)

(72) Inventor: Hironori EMARU, Santa Clara, CA (US)

(21) Appl. No.: 14/768,778

(22) PCT Filed: Jul. 29, 2013
(86) PCT No.: PCT/US13/52454

§ 371 Date: Aug. 19, 2015

(51) Int. Cl. G06F 9/455

(52) U.S. Cl. CPC G06F 9/45558; G06F 2009/45583; G06F 2009/45562

(57) ABSTRACT

A computer comprises a memory, and a processor being operable to manage a relationship between an image of a virtual machine and a plurality of storage systems forming a virtual storage system, and storing the relationship in the memory. The processor is operable to create a new image of the virtual machine in a target storage system of the plurality of storage systems based on the relationship, the new image of the virtual machine to be used to deploy the virtual machine in the target storage system. When the relationship indicates that the target storage system does not have the image, the processor is operable to copy the image from another storage system of the plurality of storage system to the target storage system and to create a new image of the virtual machine in the target storage system from the copied image in the target storage system.

### BACKGROUND OF THE INVENTION

The present invention relates generally to storage systems and, more particularly, to method and apparatus to conceal the configuration and processing of the replication (e.g., replication of virtual machine image) by virtual storage.

Virtualization technology has been used extensively. All IT infrastructures are virtualized. Storage systems are also virtualized. Virtual storage subsystem technique has the following features. One virtual storage system can be created from multiple physical storage systems. In this situation, the application does not need to be aware of each physical storage system. Even if the storage system is virtualized, however, the boundary of the physical storage system still exists. For example, a snapshot cannot be taken over the multiple physical storage systems.

U.S. Pat. No. 8,356,147 discloses tiered storage pool management and control for loosely coupled multiple storage environment. A system comprises a first storage system including a first storage controller, which receives input/output commands from host computers and provides first storage volumes to the host computers; and a second storage system including a second storage controller which receives input/output commands from host computers and provides second storage volumes to the host computers. A first data storing region of one of the first storage volumes is allocated from a first pool by the first storage controller. A second data storing region of another one of the first storage volumes is allocated from a second pool by the first storage controller. A third data storing region of one of the second storage volumes is allocated from the first pool by the second storage controller. A fourth data storing region of another one of the second storage volumes is allocated from the second pool by the second storage controller.

US 20120272021A1 discloses management system and control method for computer system to provide a storage management technique for creating and managing, with single operation by a user, a large quantity of writable snapshots, which satisfy a requirement desired by the user, while controlling a use form of a storage apparatus not to exceed limits of the performance and the capacity of the storage apparatus. Therefore, a management computer manages configuration information and performance information of plural storage apparatuses and an operation state of a writable snapshot. When a writable snapshot is created, the management computer controls, concerning an original snapshot, a use form of the storage apparatuses not to exceed a disk performance limit and a controller performance limit and a capacity limit of a storage on the basis of the number of writable snapshots to be created and a performance requirement (IOPS) and a capacity requirement of the writable snapshot.

### BRIEF SUMMARY OF THE INVENTION

Exemplary embodiments of the invention provide a technique to conceal the limitation of the physical storage systems in the virtual storage system environment when a new virtual machine is deployed using writable snapshot technology. When the virtual storage system which includes multiple physical storage systems receives an instruction to create virtual machine, a management program decides which physical storage system should be used and then creates a writable snapshot of the image appropriately. More specifically, if the selected physical storage already has the image, writable snapshot from the image is used; otherwise, the management program copies the image from another storage system and then creates a writable snapshot.

In one embodiment, the management program decides the target storage system which has enough resource to deploy the new virtual machine, then the management program checks whether the target golden image exists or not in the target storage system. Definition of the golden image in this disclosure is the original image or full copy of the original image. If the storage system has the golden image, the management program creates VM image by using writable snapshot technology. If the storage system does not have the golden image, the management program copies the golden image to the storage system, and then creates VM image by using writable snapshot technology.

In accordance with an aspect of the present invention, a computer comprises a memory, and a processor being operable to manage a relationship between an image of a virtual machine and a plurality of storage systems forming a virtual storage system, and storing the relationship in the memory. The processor is operable to create a new image of the virtual machine in a target storage system of the plurality of storage systems based on the relationship, the new image of the virtual machine to be used to deploy the virtual machine in the target storage system. When the relationship indicates that the target storage system does not have the image, the processor is operable to copy the image from another storage system of the plurality of storage system to the target storage system and to create a new image of the virtual machine in the target storage system from the copied image in the target storage system.

In some embodiments, when the relationship indicates that the target storage system does have the image, the processor is operable to create a new image of the virtual machine in the target storage system from the image in the target storage system. The processor is operable to create a new image of the virtual machine in the target storage system based on the relationship and resource conditions of the plurality of storage systems. The processor is operable to select the target storage system which has sufficient resource to deploy the virtual machine. The processor is operable to select a volume in the target storage system which has sufficient capacity to create the new image of the virtual machine. The processor is operable to select the target storage system based on a location of the target storage system and a location of said another storage system. The image is a golden image of the virtual machine and wherein the new image is a writable snapshot or a copy of the gold image. The relationship includes information identifying which storage system has the image and which storage system, if any, has a copy of the image.

Another aspect of the invention is directed to a system comprising a plurality of storage systems and a management computer. The management computer includes a memory, and a processor being operable to manage a relationship between an image of a virtual machine and the plurality of storage systems forming a virtual storage system, and storing the relationship in the memory. The processor is operable to create a new image of the virtual machine in a target storage system of the plurality of storage systems based on the relationship, the new image of the virtual machine to be used to deploy the virtual machine in the target storage system. When the relationship indicates that the target storage system does not have the image, the processor is operable to copy the image from another storage system of the plurality of storage system to the target storage system and to create a new image of the virtual machine in the target storage system from the copied image in the target storage system.

In accordance with another aspect of this invention, a computer program comprises: code for managing a relationship between an image of a virtual machine and a plurality of storage systems forming a virtual storage system, and storing the relationship in a memory; code for creating a new image of the virtual machine in a target storage system of the plurality of storage systems based on the relationship, the new image of the virtual machine to be used to deploy the virtual machine in the target storage system; and code for, when the relationship indicates that the target storage system does not have the image, copying the image from another storage system of the plurality of storage system to the target storage system and creating a new image of the virtual machine in the target storage system from the copied image in the target storage system.

Another aspect of the invention is directed to a computer-readable storage medium storing a plurality of instructions for controlling a data processor, the plurality of instructions comprising: instructions that cause the data processor to manage a relationship between an image of a virtual machine and a plurality of storage systems forming a virtual storage system, and store the relationship in a memory; instructions that cause the data processor to create a new image of the virtual machine in a target storage system of the plurality of storage systems based on the relationship, the new image of the virtual machine to be used to deploy the virtual machine in the target storage system; and instructions that cause the data processor, when the relationship indicates that the target storage system does not have the image, to copy the image from another storage system of the plurality of storage system to the target storage system and to create a new image of the virtual machine in the target storage system from the copied image in target storage system.

These and other features and advantages of the present invention will become apparent to those of ordinary skill in the art in view of the following detailed description of the specific embodiments.

### BRIEF DESCRIPTION OF THE DRAWINGS

FIG. 1 illustrates an example of a hardware configuration of a system in which the method and apparatus of the invention may be applied.

FIG. 2 shows an example of a logical configuration of the system of FIG. 1.

FIG. 3 shows an example of a logical configuration of the management server.

FIG. 4 shows an example of the image catalog table.

FIG. 5 shows an example of the configuration table according to the first embodiment.

FIG. 6 shows an example of the image management table according to the first embodiment.

FIG. 7 shows the logical configuration of the system which reflects the contents of the image management table of FIG. 6.

FIG. 8 shows an example of the GUI of the self-service portal.

FIG. 9 shows an example of a flow diagram illustrating the process of the management program in the management server.

FIG. 10 shows an example of a block diagram illustrating a process to create a plan under step 9050 of FIG. 9 by the management program of the management server.

FIG. 11 shows an example of the configuration table according to the second embodiment.

FIG. 12 shows an example of the image management table according to the second embodiment.

FIG. 13 shows an example of an updated image management table.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium including non-transitory medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for concealing the limitation of the physical storage systems in the virtual storage system environment when a new virtual machine is deployed using writable snapshot technology.

### EMBODIMENT 1

The first embodiment discloses how the management program decides the target storage system to deploy a new virtual machine when it receives instruction to create new virtual machine.

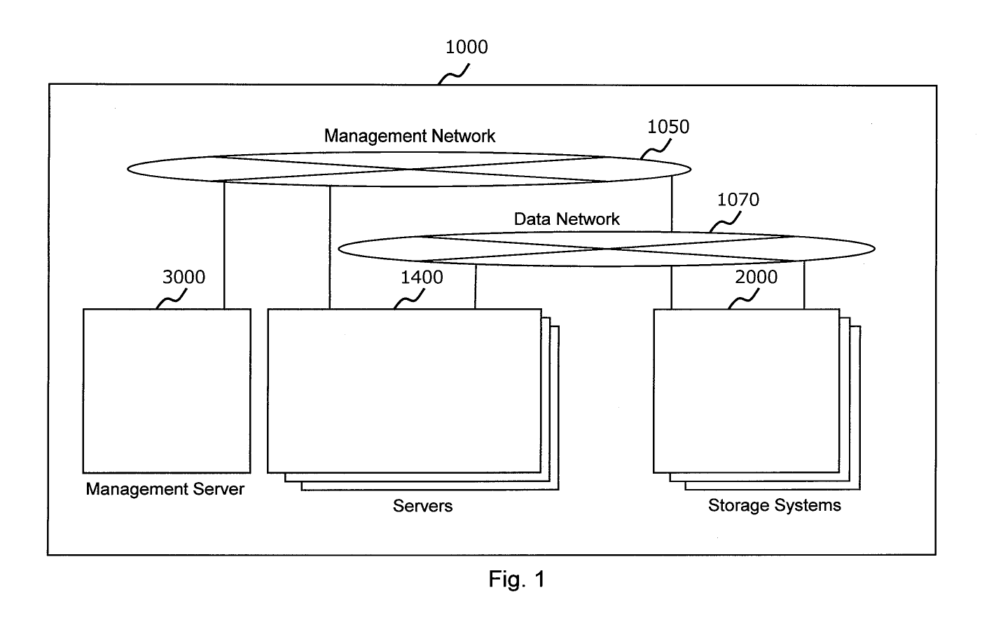

FIG. 1 illustrates an example of a hardware configuration of a system in which the method and apparatus of the invention may be applied. The system 1000 includes a management server 3000, servers 1400, and storage systems 2000. The servers 1400 and storage systems 2000 are connected via a Data Network 1070. The network is usually a WAN (Wide Area Network), but it is not limited to this. The management server 3000, servers 1400, and storage systems 2000 are connected via a management. network 1050. The network is usually a WAN, but it is not limited to this. In the embodiment shown, the management network and data network are separate, but the invention is not limited to this. In the embodiment shown, the management server 3000 and servers 1400 are separate, but the invention is not limited to this. For example, any server can host a management server. In the embodiment shown, the servers 1400 and storage systems 2000 are separate, but the invention is not limited to this. For example, the server and storage system can be combined into one system.

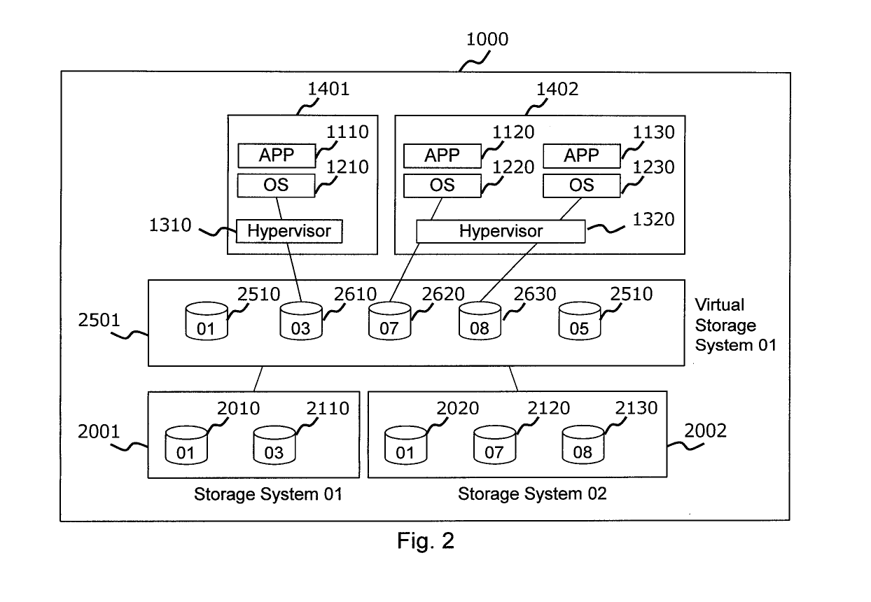

FIG. 2 shows an example of a logical configuration of the system 1000 of FIG. 1. Applications 1110 and OSs 1210 run on the hypervisor 1310. The hypervisor 1310 runs on the server 1401. Application 1120, 1130 and OS 1220, 1230 run on the hypervisor 1320. The hypervisor 1320 runs on the server 1402. Application 1110 uses virtual volume 2610 of the virtual storage system 01 2501. Application 1120 uses virtual volume 2620 of the virtual storage system 01 2501. Application 1130 uses virtual volume 2630 of the virtual storage system 01 2501. These virtual volumes 2610, 2620, and 2630 are provisioned from physical storage systems 01 2001 and 02 2002.

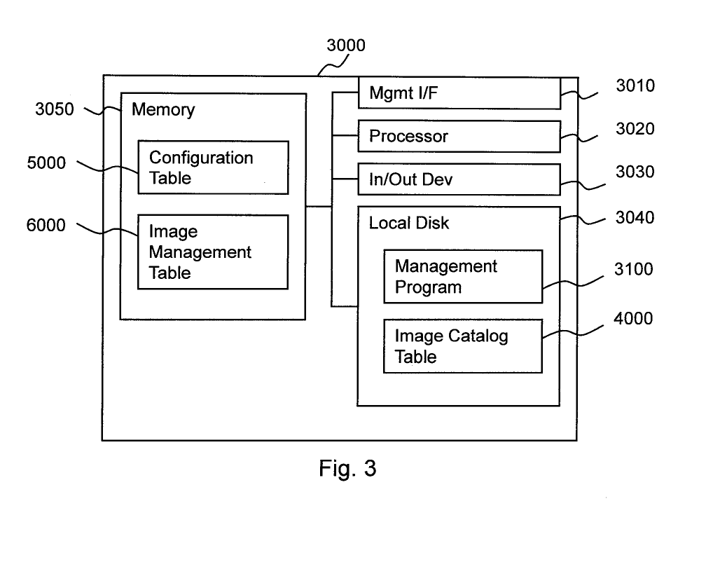

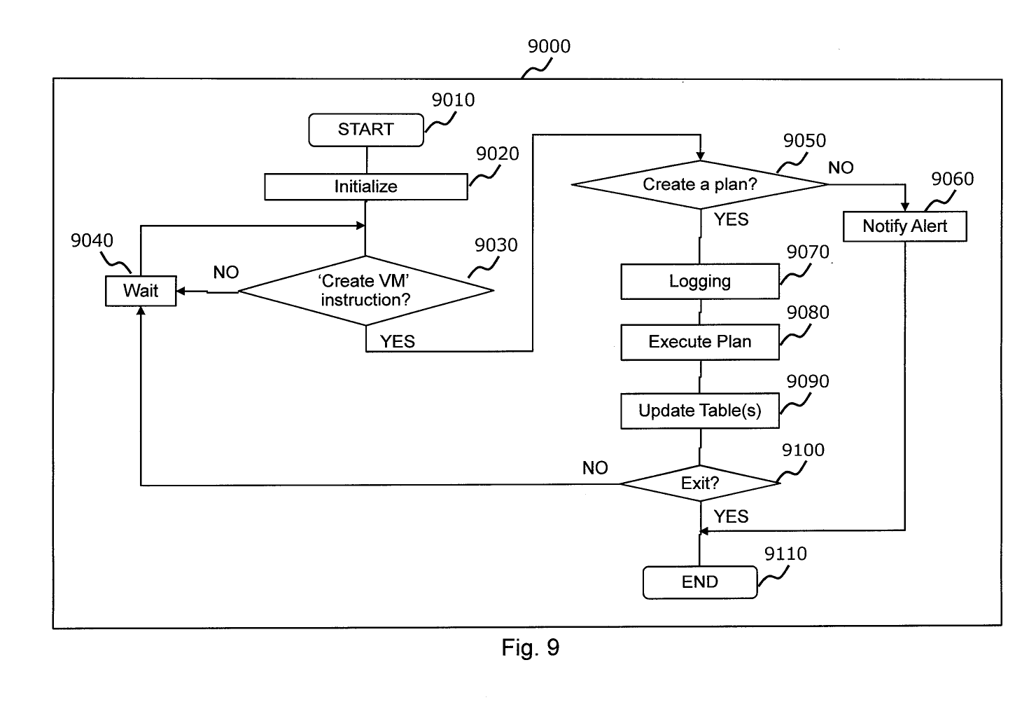

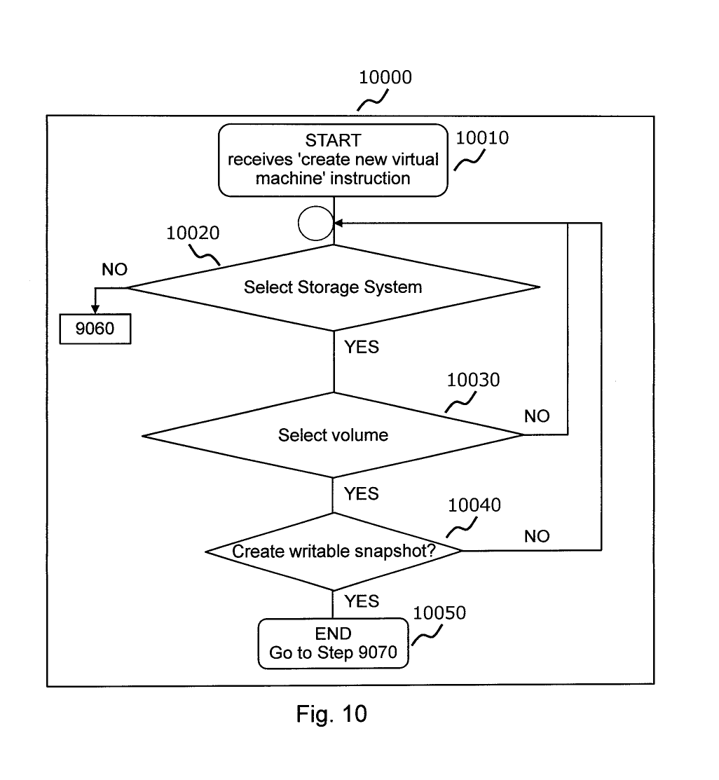

FIG. 3 shows an example of a logical configuration of the management server 3000. Management interface 3010 is an interface to the management network 1050. Input and output device 3030 is a user interface such as monitor, keyboard, and mouse. Local Disk 3040 contains management program 3100 and image catalog table 4000. The management program 3100 is loaded to the memory 3050 and executed by the processor 3020. The procedure of the management program 3100 is described in connection with FIG. 9 and FIG. 10. The image catalog table 4000 is loaded to the memory 3050 and used by the management program 3100. The memory 3050 contains configuration table 5000 and image management table 6000. Each table is described below.

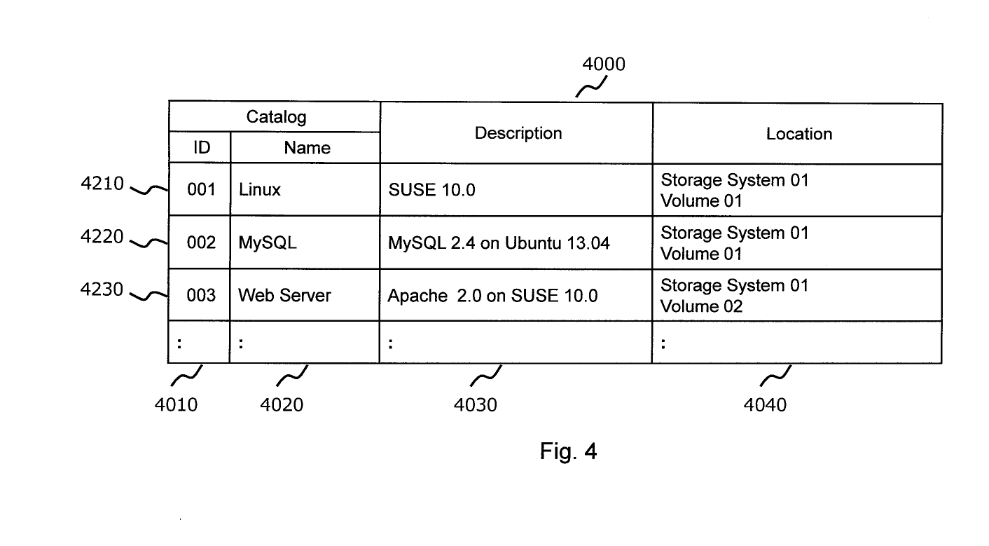

FIG. 4 shows an example of the image catalog table 4000. The image catalog table is referred to when the administrator provisions IT resources by using a self-service portal. This table is loaded from the local disk 3040 to the memory 3050 of the management server 3000. Column 4010 shows the identification of the catalog. Column 4020 shows the name of the catalog. Column 4030 shows the description of the catalog. Column 4040 shows the location of this golden image. Each row (4210, 4220, 4230) shows an image catalog. For example, row 4210 shows the catalog of Linux. This catalog has the SUSE 10.0 Linux image. This image is located on volume 01 of storage system 01.

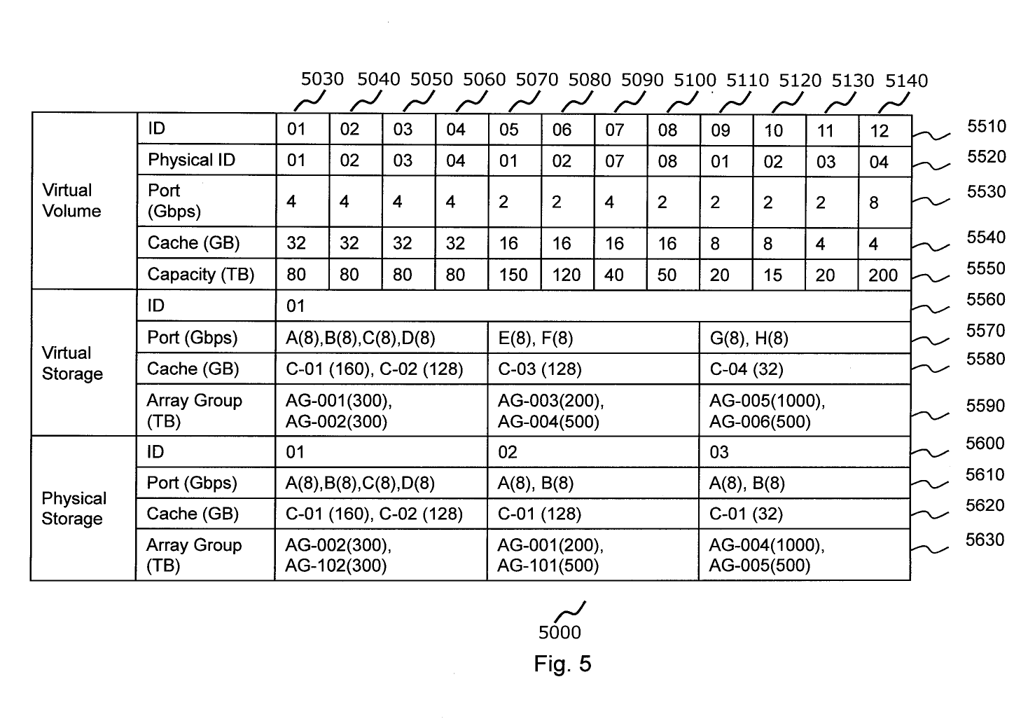

FIG. 5 shows an example of the configuration table 5000 according to the first embodiment. This table is created in the memory 3050 by the management program 3100. Rows 5510 to 5550 show the information of the virtual volume. Row 5510 shows the identification of the virtual volume. Row 5520 shows the identification of the physical volume. Row 5530 shows the assigned port resources to each volume. For example, 4 Gbps of port resources are assigned to volume 01. Row 5540 shows the assigned cache resources to each volume. For example, 32 GB of cache resources are assigned to volume 01. Row 5550 shows the assigned capacity to each volume. For example, 80 TB of capacity is assigned to volume 01.

Rows 5560 to 5590 show the information of the virtual storage system. Row 5560 shows the identification of the virtual storage system. Row 5570 shows the assigned port resources to each virtual storage system. For example, 8 Gbps of port A, B, C, D, E, F, G, and H are assigned to virtual storage 01. Row 5580 shows the assigned cache resources to each virtual storage system. For example, 160 GB of cache C-01, 128 GB of cache C-02, 128 GB of cache C-03, and 32 GB of cache C-04 are assigned to virtual storage 01. Row 5590 shows the assigned array groups to each virtual storage system. For example, 300 TB of array group AG-001, 300 TB of array group AG-002, 200 TB of array group AG-003, 500 TS of array group AG-004, 1000 TB of array group AG-005, and 500 TB of array group AG-006 are assigned to virtual storage 01.

Rows 5600 to 5630 show the information of the physical storage system. Row 5600 shows the identification of the physical storage system. Row 5610 shows the port resources in each physical storage system. For example, storage system 01 has 8 Gbps of port A, B, C, and D. Row 5620 shows the cache resources in each physical storage system. For example, storage system 01 has 160 GB of cache C-01 and 128 GB of cache C-02. Row 5630 shows the array group resources in each physical storage system. For example, storage system 01 has 300 TB of array group AG-002 and 300 TS of array group AG-102. Each column (5030 to 5140) shows the resource configuration of a volume. For example, column 5030 shows the resource configuration of the volume 01. 4 Gbps of port resources, 32 Gbps of cache resources, and 80 TB of capacity are assigned to the volume 01. This volume is provisioned from virtual storage 01 and resources are carved from physical storage 01.

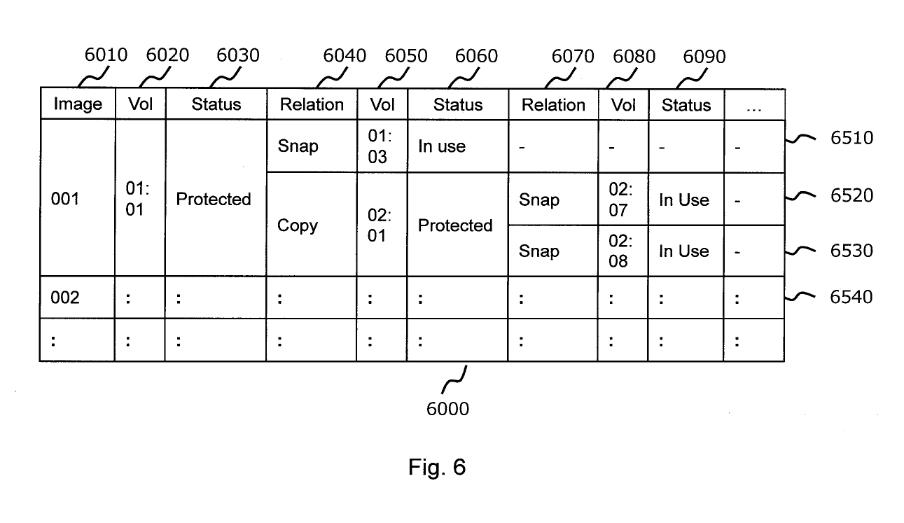

FIG. 6 shows an example of the image management table 6000 according to the first embodiment. In this embodiment, an application can only use the writable snapshot image. Therefore, writable snapshot should be taken from the golden image or full copy of the golden image for the application. Columns 6010, 6020, and 6030 show the information of the golden images. Column 6010 shows the identification of the image. Detailed information of this image is shown in the image catalog table 4000 in FIG. 4. Column 6020 shows the identification of the physical storage and physical volume which contain this image. The entry “01:01” means the physical storage identification is 01 and the physical volume identification is 01. Column 6030 shows the status of this image. The entry “Protected” means this image is write protected. Because this is a golden image, writable snapshot should be taken from this image to be used.

Columns 6040, 6050, and 6060 show the information of the secondary images. Column 6040 shows the relation between the golden image and secondary image. There are two types of relations. The first one is “Copy”. In this case, the secondary image is a full copy of the golden image. The second one is “Snap”. In this case, the secondary image is a writable snapshot of the golden image. Column 6050 shows the identification of the physical storage and physical volume which contain this secondary image. Column 6060 shows the status of this image. The entry “Protected” means this image is write protected. Because this is a copy of the golden image, writable snapshot should be taken from this image to be used. The entry “In use” means this image is a writable snapshot of the golden image and it is used for the application.

Columns 6070, 6080, and 6090 show the information of the third images. Column 6070 shows the relation between the secondary image and third image. There are two types of relations. The first one is “Copy”. In this case, the third image is a full copy of the secondary image. The second one is “Snap”. In this case, the third image is a writable snapshot of the secondary image. Column 6080 shows the identification of the physical storage and physical volume which contain this third image. Column 6090 shows the status of this image. The entry “Protected” means this image is write protected. Because this is a copy of the golden image, writable snapshot should be taken from this image to be used. The entry “In use” means this image is a writable snapshot of the golden image and it is used for the application.

Each row (6510-6540) shows the relation for a volume. For example, row 6530 shows that the golden image of the image 001 is stored in volume 01, a full copy of this image is stored in volume 05, and a writable snapshot of this image is stored in volume 08. This figure contains up to the third level, but it is not limited to this. Fourth, fifth, and more levels can be added.

In the above description, the application only can use the writable snapshot image, but the invention is not limited to this. The application can use the full copy of the golden image. Writable snapshot is quick to deploy but it is difficult to balance the I/O workload. Therefore, it is possible to use the full copy image instead of the writable snapshot.

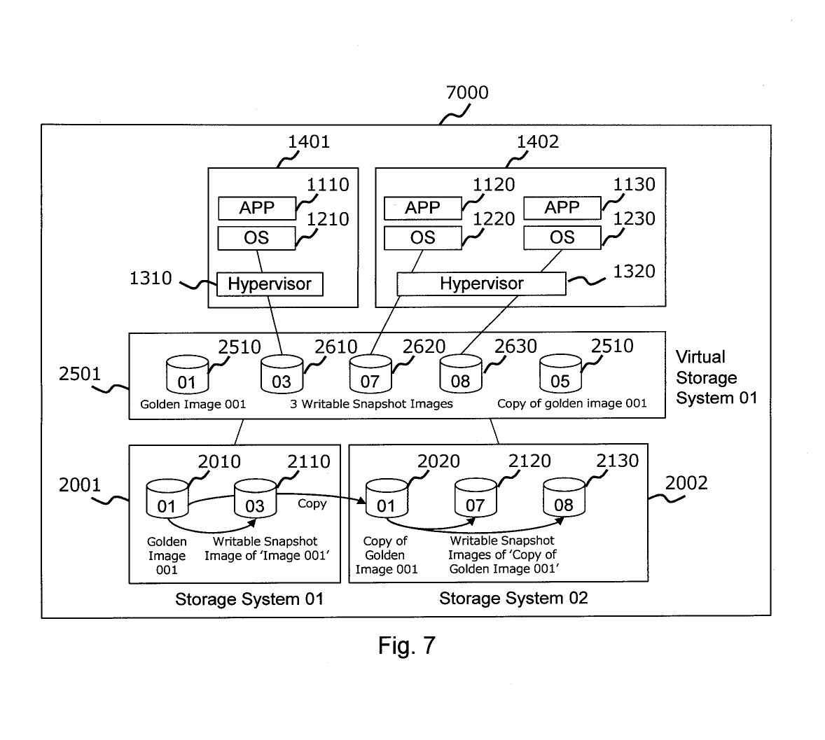

FIG. 7 shows the logical configuration of the system 1000 which reflects the contents of the image management table 6000 of FIG. 6. This figure is almost the same as FIG. 2. Logical data placement is as follows. In the virtual storage system layer, the golden image 001 is stored in volume 01 of the virtual storage system 01 and full copy of the golden image is stored in volume 05 of the virtual storage system 01. Three writable snapshots of the golden image 001 are stored in volume 03, 07, and 08 of the virtual storage system 01. Physical data placement is as follows. In the physical storage system layer, the golden image 001 is stored in volume 01 of the storage system 01 and full copy of the golden image is stored in volume 01 of the storage system 02. One writable snapshot of the golden image 001 in volume 01 of the storage system 01 is stored in volume 03 of the storage system 01. Two writable snapshots of the golden image 001 in volume 01 of the storage system 02 are stored in volumes 07 and 08 of the storage system 02.

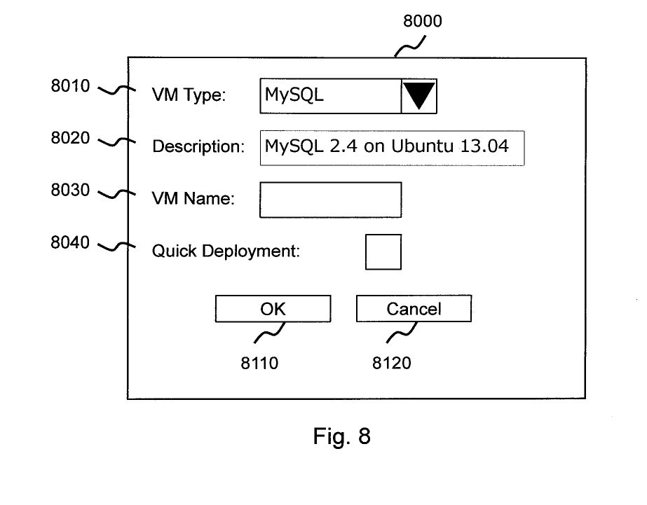

FIG. 8 shows an example of the GUI (Graphical User Interface) 8000 of the self-service portal. This self-service portal GUI is used when the administrator wants to provision virtual machine resources and its storage resources. The administrator selects the application type 8010 (e.g., “MySQL”). Candidates are displayed based on the image catalog name 4020 of the image catalog table 4000. When he/she selects the VM type, description is displayed by referring to the description 4030 in the image catalog table 4000. The administrator checks a “quick deployment checkbox” 8040, if he/she wants to deploy a virtual machine quickly. This checkbox is optional. Then, he/she inputs a VM name 8020 (e.g., “MySQL-A”). If the “Cancel” button 8120 is pressed, the management program 3100 cancels the provisioning process. If the “OK” button 8110 is pressed, the management program 3100 issues a “Create VM” instruction. How to process this instruction is described below by using the flow diagram 9000 of FIG. 9.

FIG. 9 shows an example of a flow diagram illustrating the process of the management program 3100 in the management server 3000. The program starts at Step 9010. In Step 9020, the program initializes. The management program 3100 creates the configuration table 5000 and image management table 6000 in the memory 3050. Then, the management program 3100 loads the image catalog table 4000 from the local disk 3040 to the memory 3050 in the management server 3000. Next, the virtual storage system is created by the administrator. The administrator configures the port, cache, and capacity of the virtual storage system. This result is reflected in the configuration table 5000. Then, the virtual volumes are created by the administrator. The administrator configures the port, cache, and capacity of each virtual volume. This result is reflected in the configuration table 5000.

In Step 9030 the management program 3100 checks whether a “Create VM” instruction has arrived or not. If the “Create VM” instruction has arrived, the program goes to step 9050; otherwise, it goes to step 9040. In Step 9040, the program waits for a while, and then goes back to Step 9030. In Step 9050, the management program 3100 tries to create a plan. How to create a plan is described in the flow diagram 10000 of FOG. 10. If the program succeeds in creating a plan, the program goes to step 9070; otherwise, it goes to step 9060. Step 9060 involves an alert. Because the management program 3100 cannot create a plan, it notifies an alert to the administrator. The program then ends at step 9110. If the management program 3100 succeeds in creating a plan, it logs the created plan in Step 9070. In Step 9080, the program executes the created plan. Based on the executed plan, configuration will change. Therefore, the configuration table 5000 is updated in Step 9090. In Step 9100, the program checks whether there is a termination indication by the user. If a termination indication exists, the program ends at step 9110; otherwise, it goes back to step 9040.

FIG. 10 shows an example of a block diagram illustrating a process to create a plan under step 9050 of FIG. 9 by the management program 3100 of the management server 3000. The program starts at Step 10010, when the management program receives “create new virtual machine” instruction. In Step 10020, the program selects a storage system. If the administrator checks the “quick deployment checkbox” 8040 in the self-service portal GUI 8000, management program 3100 selects one physical storage system which has enough resource to deploy the new virtual machine and contains specified and “Protected” image by referring to the image catalog table 6000. If the management program 3100 cannot find a storage system that satisfies the above condition, the management program 3100 selects a physical storage system which has enough resource to deploy the new virtual machine by referring to the image catalog table 6000. If the administrator does not check the “quick deployment checkbox” 8040 in the self-service portal GUI 8000, the management program 3100 selects a physical storage system which has enough resource to deploy the new virtual machine. If there is no physical storage which has enough storage resources, then the management program 3100 goes to step 9060 (notify alert).

In Step 10030, the management program 3100 selects a volume which has enough capacity to create a writable snapshot of the specified image. If management program 3100 cannot find a volume which satisfies the above condition, then the management program 3100 goes back to step 10020. In Step 10040, the management program 3100 checks whether the physical storage system which contains the selected volume has enough resources to provision the new VM. If the selected volume does not have enough resources, then the management program 3100 goes back to step 10020. If the selected volume has enough resources, the management program 3100 creates a writable snapshot of the specified image. If selected storage system has a protected image, the management program 3100 only creates a writable snapshot from the protected image. If selected storage system does not have a protected image, the management program 3100 copies the protected image from another storage system, and then creates a writable snapshot from the copied image. For example, it is assumed that Linux image (ID=001) is selected at application type 12010 in provisioning GUI 8000 and storage system 03 is selected in step 10020. In this case, the storage system 03 does not have a Linux image, and hence the management program 3100 copies the image from another storage system (e.g., storage system 01), and then creates a writable snapshot from the copied image.

In this embodiment, the management program receives a “create new virtual machine” instruction, and then the management program decides the target storage system which has enough resource to deploy the new virtual machine, and then the management program checks whether the target golden image exists or not in the target storage system. If the storage system has the golden image, the management program creates a VM image by using writable snapshot technology. If the storage system does not have golden image, the management program copies the golden image to the storage system, and then creates a VM image by using writable snapshot technology. By doing this, the management program can conceal the limitation of the physical storage systems in the virtual storage system environment when the new virtual machine is deployed using writable snapshot technology.

### EMBODIMENT 2

Copy performance among physical storage systems may differ, especially in a multi-site environment. In embodiment 2, how to select the optimal physical storage system pair is disclosed.

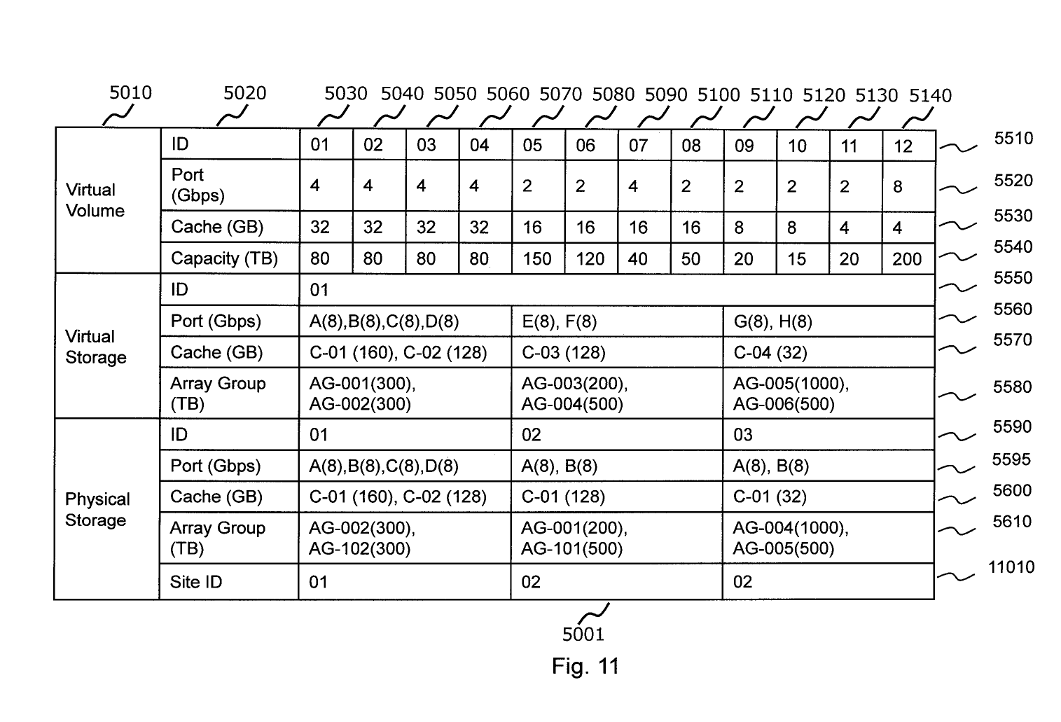

FIG. 11 shows an example of the configuration table 5001 according to the second embodiment. This table 5001 is almost the same as the configuration table 5000 of the first embodiment shown in FIG. 5. Only the differences are described. In FIG. 11, row 11010 is added. Row 11011 shows the identification of the site of the physical storage system. For example, physical storage system 01 is located in site 01 and physical storage systems 02 and 03 are located in site 02. How to create a plan accordingly to the second embodiment is disclosed next.

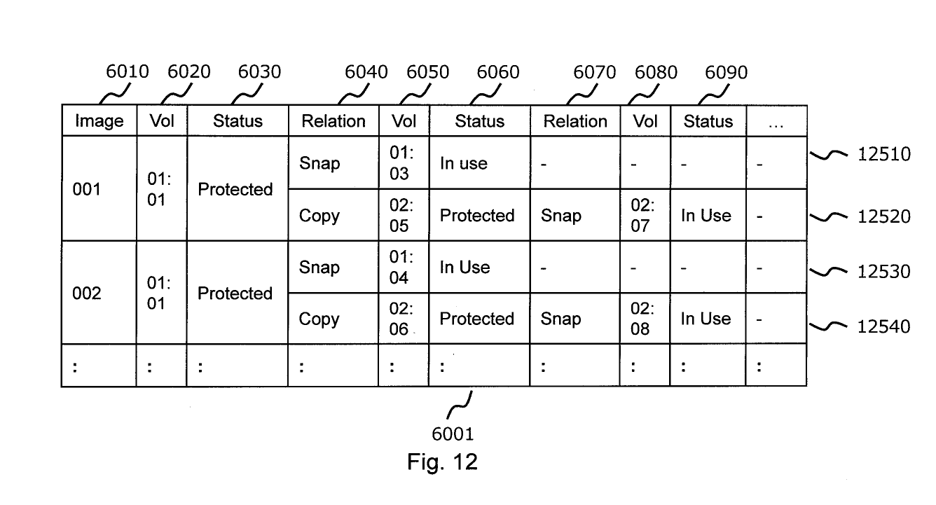

FIG. 12 shows an example of the image management table 6001 according to the second embodiment. This table is the same as the image management table 6000 of the first embodiment shown in FIG. 6. Only the contents are different, as shown in rows 12510-12540 instead of rows 6510-6540 of FIG. 6. It is assumed that physical storage 01 and 02 do not have enough resources to deploy a new VM and physical storage 03 has enough resources to deploy a new VM. It is assumed that the management program 3100 receives a “Create VM” instruction of image 002. In this case, the management program 3100 should copy image 002 to physical storage system 03. Candidates of the copy source include volume 01 of the physical storage 01 and volume 06 of the physical storage 02. Physical storage system 01 is in site 01 and physical storage systems 02 and 03 are in site 02. Because physical storage system 02 is in the same site as physical storage system 03, the management program 3100 selects physical storage 02 as a copy source. As a result, image 002 is copied from volume 06 of the physical storage 02 to volume 09 of the physical storage 03, and then writable snapshot is created in volume 11 of the physical storage 03 from image 002 in volume 09 of the physical storage 03.

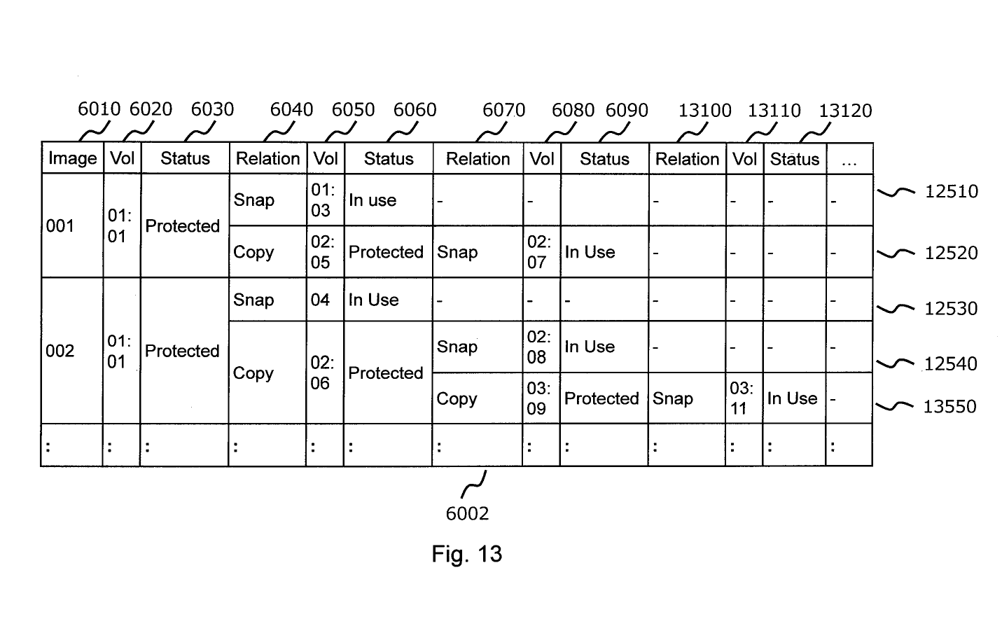

FIG. 13 shows an example of an updated image management table 6002. This table is updated from the image management table of FIG. 12 according to Step 9090 of FIG. 9. New row 13550 is added. It shows a copy relation between secondary image in volume 02:06 and third image in volume 03:09 which is protected, and snapshot relation between the image in volume 03:09 and the image in volume 03:11 which is in use.

In the second embodiment, the management program 3100 selects the optimal copy source and target storage systems by using site information, but the invention is not limited to this. For example, the management program 3100 gets distance information among the storage systems, and then selects the nearest pair that can be used. In another example, the management program 3100 gets the turnaround time among the storage systems, and then selects the shortest time pair that can be used.

This invention discloses how to decrease the cost to execute the application, especially in the cloud environment. The management program provides the recommended plan to decrease the cost.

Of course, the system configuration illustrated in FIG. 1 is purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for concealing the limitation of the physical storage systems in the virtual storage system environment when a new virtual machine is deployed using writable snapshot technology. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A computer comprising:
a memory; and
a processor being operable to manage a relationship between an image of a virtual machine and a plurality of storage systems forming a virtual storage system, and storing the relationship in the memory;
wherein the processor is operable to create a new image of the virtual machine in a target storage system of the plurality of storage systems based on the relationship, the new image of the virtual machine to be used to deploy the virtual machine in the target storage system; and
wherein when the relationship indicates that the target storage system does not have the image, the processor is operable to copy the image from another storage system of the plurality of storage system to the target storage system and to create a new image of the virtual machine in the target storage system from the copied image in the target storage system.

2. The computer according to claim 1,
wherein when the relationship indicates that the target storage system does have the image, the processor is operable to create a new image of the virtual machine in the target storage system from the image in the target storage system.

3. The computer according to claim 1,
wherein the processor is operable to create a new image of the virtual machine in the target storage system based on the relationship and resource conditions of the plurality of storage systems.

4. The computer according to claim 3,
wherein the processor is operable to select the target storage system which has sufficient resource to deploy the virtual machine.

5. The computer according to claim 4,
wherein the processor is operable to select a volume in the target storage system which has sufficient capacity to create the new image of the virtual machine.

6. The computer according to claim 1,
wherein the processor is operable to select the target storage system based on a location of the target storage system and a location of said another storage system.

7. The computer according to claim 1,
wherein the image is a golden image of the virtual machine and wherein the new image is a writable snapshot or a copy of the gold image.

8. The computer according to claim 1,
wherein the relationship includes information identifying which storage system has the image and which storage system, if any, has a copy of the image.

9. A system comprising a plurality of storage systems and a management computer, the management computer including:
a memory; and
a processor being operable to manage a relationship between an image of a virtual machine and the plurality of storage systems forming a virtual storage system, and storing the relationship in the memory;
wherein the processor is operable to create a new image of the virtual machine in a target storage system of the plurality of storage systems based on the relationship, the new image of the virtual machine to be used to deploy the virtual machine in the target storage system; and
wherein when the relationship indicates that the target storage system does not have the image, the processor is operable to copy the image from another storage system of the plurality of storage system to the target storage system and to create a new image of the virtual machine in the target storage system from the copied image in the target storage system.

10. The system according to claim 9,
wherein when the relationship indicates that the target storage system does have the image, the processor is operable to create a new image of the virtual machine in the target storage system from the image in the target storage system.

11. The system according to claim 9,
wherein the processor is operable to create a new image of the virtual machine in the target storage system based on the relationship and resource conditions of the plurality of storage systems.

12. The system according to claim 11,
wherein the processor is operable to select the target storage system which has sufficient resource to deploy the virtual machine.

13. The system according to claim 9,
wherein the processor is operable to select the target storage system based on a location of the target storage system and a location of said another storage system.

14. The system according to claim 9,
wherein the image is a golden image of the virtual machine and wherein the new image is a writable snapshot or a copy of the gold image.

15. The system according to claim 9,
wherein the relationship includes information identifying which storage system has the image and which storage system, if any, has a copy of the image.

16. A computer program comprising:
code for managing a relationship between an image of a virtual machine and a plurality of storage systems forming a virtual storage system, and storing the relationship in a memory;
code for creating a new image of the virtual machine in a target storage system of the plurality of storage systems based on the relationship, the new image of the virtual machine to be used to deploy the virtual machine in the target storage system; and
code for, when the relationship indicates that the target storage system does not have the image, copying the image from another storage system of the plurality of storage system to the target storage system and creating a new image of the virtual machine in the target storage system from the copied image in the target storage system.

17. The computer program according to claim 16, further comprising:
code for, when the relationship indicates that the target storage system does have the image, creating a new image of the virtual machine in the target storage system from the image in the target storage system.

18. The computer program according to claim 16, further comprising:
code for creating a new image of the virtual machine in the target storage system based on the relationship and resource conditions of the plurality of storage systems.

19. The computer program according to claim 16, further comprising:
code for selecting the target storage system based on a location of the target storage system and a location of said another storage system.

20. The computer program according to claim 16,
wherein the relationship includes information identifying which storage system has the image and which storage system, if any, has a copy of the image.
